(19) United States
(12) Patent Application Publication
(10) Pub. No.: US 2016/0292803 A1
(43) Pub. Date: Oct. 6, 2016

(54) Document Analysis System, Document Analysis Method, and Document Analysis Program

(71) Applicant: UBIC, Inc., Tokyo (JP)

(72) Inventors: Masahiro MORIMOTO, Tokyo (JP); Hideki TAKEDA, Tokyo (JP); Kazumi HASUKO, Tokyo (JP)

(21) Appl. No.: 14/391,628

(22) PCT Filed: Mar. 17, 2014
(86) PCT No.: PCT/JP2014/057106

§ 371 Date: Oct. 9, 2014

(30) Foreign Application Priority Data
Sep. 11, 2013 (JP) 2013-188379

(51) Int. Cl. G06Q 50/18; G06F 17/30

(52) U.S. Cl. CPC G06Q 50/18; G06F 17/30011; G06F 17/30598

(57) ABSTRACT

A document analysis system obtains digital information recorded in plural computers or servers, analyzes document information configured by plural documents, included in the obtained digital information, and provides the document information for easy use in a lawsuit or an illegality inspection. The document analysis system includes: an inspection category input receiving unit that receives an input of a category of the lawsuit or the illegality inspection; an inspecting unit that performs an inspection based on the category received by the inspection category input receiving unit; and a report preparing unit that prepares a report for reporting a result of the inspection performed by the inspecting unit.

### BACKGROUND OF THE INVENTION

1. Field of the Invention

The present invention relates to a document analysis system, a document analysis method, and a document analysis program.

2. Background Art

In the related art, when a crime or a legal dispute relating to a computer such as unauthorized access or confidential information leakage occurs, means or a technique for collecting and analyzing devices, data, and electronic records necessary for cause examination or criminal investigation to clarify legal evidentiality has been proposed.

Particularly, in a US civil suit, eDiscovery (electronic discovery) or the like is required, and both of an accuser and a defendant in a lawsuit should submit related digital information as evidence. Thus, digital information recorded in a computer or a server should be presented as evidence.

On the other hand, in a current business world, since most information is prepared by a computer according to rapid development and spread of IT technology, a large amount of digital information is oversupplied even in the same company.

Thus, in the course of performing preparation work for producing evidentiary materials for a law court, an error that even confidential digital information that is not necessarily related to a lawsuit is included as the evidentiary materials may easily occur. Further, confidential document information that is not related to the lawsuit may be produced.

In recent years, a technique relating to document information in a forensic system has been proposed in Japanese Unexamined Patent Application Publication No. 2011-209930, Japanese Unexamined Patent Application Publication No. 2011-209931, and Japanese Unexamined Patent Application Publication No. 2012-32859. Japanese Unexamined Patent Application Publication No. 2011-209930 discloses a forensic system that designates a specific person from at least one or more users included in user information, extracts only digital document information that is accessed by the specific person based on access history information relating to the designated specific person, sets accessory information indicating whether each of document files of the extracted digital document information is related to the lawsuit, and outputs a document file relating to the lawsuit based on the accessory information.

Further, Japanese Unexamined Patent Application Publication No. 2011-209931 discloses a forensic system that displays recorded digital information, sets user specific information indicating which user among users included in user information each of plural document files relates to, sets the set user specific information to be recorded in a storing unit, designates at least one or more users, retrieves a document file for which the user specific information corresponding to the designated user is set, sets accessory information indicating whether the retrieved document file is related to a lawsuit, and outputs the document file relating to the lawsuit based on the accessory information through a display unit.

In addition, Japanese Unexamined Patent Application Publication No. 2012-32859 discloses a forensic system that receives designation of at least one or more document files included in digital document information, receives designation of a language for translating the designated document file, translates the document file of which the designation is received into the language of which the designation is received, extracts a common document file that represents the same content as that of the designated document file from the digital document information recorded in a recording unit, generates translation related information indicating that the extracted common document file is translated by quoting the translation content of the translated document file, and outputs a document file relating to a lawsuit based on the translation related information.

### SUMMARY OF THE INVENTION

However, for example, in the forensic systems in Japanese Unexamined Patent Application Publication No. 2011-209930, Japanese Unexamined Patent Application Publication No. 2011-209931, and Japanese Unexamined Patent Application Publication No. 2012-32859, a huge amount of document information of users made by plural computers and servers should be collected.

Work for determining whether the huge amount of digital document information is valid as evidentiary materials for a lawsuit should be performed by visual confirmation of a user called a reviewer, and the document information should be classified piece by piece, which causes a large amount of labor and high cost.

An object of the invention is to provide a document analysis system, a document analysis method, and a document analysis program for facilitating analysis of document information used in a lawsuit.

According to an aspect of the invention, there is provided a document analysis system that obtains digital information recorded in a plurality of computers or servers, analyzes document information configured by a plurality of documents, included in the obtained digital information, and provides the document information for easy use in a lawsuit or an illegality inspection, including: an inspection category input receiving unit that receives an input of a category of the lawsuit or the illegality inspection; an inspecting unit that performs an inspection based on the category received by the inspection category input receiving unit; and a report preparing unit that prepares a report for reporting a result of the inspection performed by the inspecting unit.

In the document analysis system, the report preparing unit may prepare a report suitable for the category received by the inspection category input receiving unit based on the result of the inspection performed by the inspecting unit.

The document analysis system may further include: an inspection base database that stores information relating to the lawsuit or the illegality inspection; and an inspection type determining unit that determines an inspection category which is an inspection target based on the category received by the inspection category input receiving unit, and extracts the type of necessary information from the inspection base database.

The document analysis system may further include: a display screen control unit that controls a display screen that presents the type of the information extracted by the inspection type determining unit to a user.

The document analysis system may further include: an input receiving unit that receives an input of a keyword and/or a sentence from the user, corresponding to the type of the information presented in the display screen control unit.

The document analysis system may further include: an information extracting unit that extracts a keyword and/or a sentence, corresponding to the type of the information extracted by the inspection type information determining unit, from the inspection base database.

The document analysis system may further include: a retrieving unit that retrieves the keyword and/or the sentence from the document.

The document analysis system may further include an automatic classification code assigning unit that automatically assigns the classification code to the document, in which the keyword and/or the sentence may be used in the assignment of the classification code.

According to another aspect of the invention, there is provided a document analysis method for obtaining digital information recorded in a plurality of computers or servers, analyzing document information configured by a plurality of documents, included in the obtained digital information, and providing the document information for easy use in a lawsuit or an illegality inspection, including: receiving an input of a category of the lawsuit or the illegality inspection; performing an inspection based on the category received in the receiving of the input; and preparing a report for reporting a result of the inspection in the performing of the inspection.

According to still another aspect of the invention, there is provided a document analysis program for obtaining digital information recorded in a plurality of computers or servers, analyzing document information configured by a plurality of documents, included in the obtained digital information, and providing the document information for easy use in a lawsuit or an illegality inspection, the program causing a computer to execute functions including: an inspection category input receiving function of receiving an input of a category of the lawsuit or the illegality inspection; an inspection function of performing an inspection based on the category received through the inspection category input receiving function; and a report preparing function of preparing a report for reporting a result of the inspection performed through the inspection function.

According to the document analysis system, the document analysis method, and the document analysis program of the invention, it is possible to facilitate analysis of document information used in a lawsuit.

### BRIEF DESCRIPTION OF THE DRAWINGS

FIG. 1 is a configuration diagram illustrating a document determination system according to an embodiment of the invention.

FIG. 2 is a chart illustrating the flow of processes in a document analysis method according to an embodiment of the invention.

FIG. 3 is a chart illustrating the flow of an inspection and classification process according to the type of inspection in a document analysis method according to an embodiment of the invention.

FIG. 4 is a chart illustrating the flow of a prediction coding process according to the type of inspection in a document analysis method according to an embodiment of the invention.

FIG. 5 is a chart illustrating the flow of a process in each step in an embodiment.

FIG. 6 is a chart illustrating a processing flow of a keyword database in an embodiment.

FIG. 7 is a chart illustrating a processing flow of an associated word database in the present embodiment.

FIG. 8 is a chart illustrating a processing flow of a first automatic classifying unit in the present embodiment.

FIG. 9 is a chart illustrating a processing flow of a second automatic classifying unit in the present embodiment.

FIG. 10 is a chart illustrating a processing flow of a classification code receiving and assigning unit in the present embodiment.

FIG. 11 is a chart illustrating a processing flow of a document analyzing unit in the present embodiment.

FIG. 12 is a graph illustrating an analysis result in the document analyzing unit in the present embodiment.

FIG. 13 is a chart illustrating a processing flow of a third automatic classifying unit in an example of the present embodiment.

FIG. 14 is a chart illustrating a processing flow of a third automatic classifying unit in another example of the present embodiment.

FIG. 15 is a chart illustrating a processing flow of a quality inspecting unit in the present embodiment.

FIG. 16 is a diagram illustrating a document display screen in the present embodiment.

### DETAILED DESCRIPTION OF THE INVENTION

A document analysis system of the invention will be described.

The document analysis system of the invention is a document analysis system that obtains digital information recorded in plural computers or servers, analyzes document information configured by plural documents, included in the obtained digital information, and provides the information for easy use in a lawsuit or an illegality inspection.

The document analysis system includes an inspection category input receiving unit, an inspecting unit, and a report preparing unit.

The inspection category input receiving unit receives an input of a category of a lawsuit or an illegality inspection.

The inspecting unit performs an inspection based on the category received by the inspection category input receiving unit.

The report preparing unit prepares a report for reporting a result of the inspection performed by the inspecting unit.

The report preparing unit may prepare a report suitable for the category received by the inspection category input receiving unit based on the result of the inspection performed by the inspecting unit.

The document analysis system includes an inspection base database, and an inspection type determining unit.

The inspection base database stores information relating to the lawsuit or the illegality inspection.

The inspection type determining unit determines an inspection category that is an inspection target based on the category received by the inspection category input receiving unit, and extracts the type of necessary information from the inspection base database.

The document analysis system may further include a display screen control unit that controls a display screen that presents the type of the information extracted by the inspection type determining unit to a user.

In this case, the document analysis system may further include an input receiving unit that receives an input of a keyword and/or a sentence from the user, corresponding to the type of the information presented by the display screen control unit.

The document analysis system may further include an information extracting unit that extracts a keyword and/or a sentence, corresponding to the type of the information extracted by the inspection type determining unit, from the inspection base database.

The document analysis system may further include a retrieving unit that retrieves a keyword and/or a sentence from a document.

The document analysis system may further include an automatic classification code providing unit that automatically assigns a classification code to the document, in which a keyword and/or a sentence may be used in the assignment of the classification code.

Subsequently, details of the document analysis system of the invention will be specifically described with reference to the accompanying drawings. Examples described hereinafter are only examples, and the invention is not limited thereto.

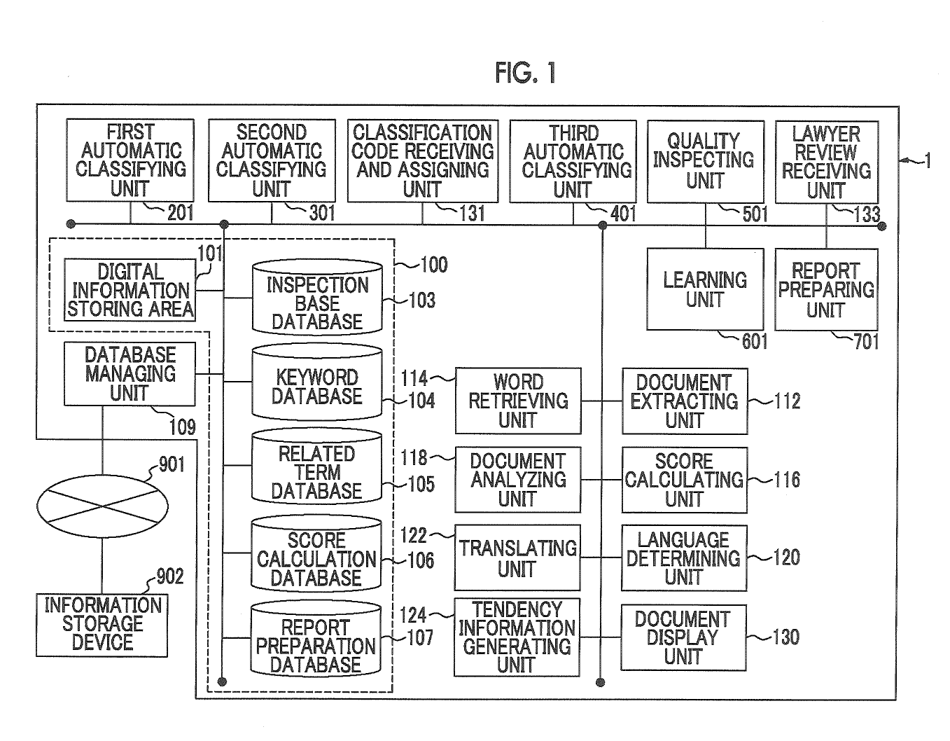

FIG. 1 is a diagram illustrating an example of a configuration of the document analysis system according to an embodiment of the invention.

As shown in FIG. 1, a document analysis system 1 according to the present embodiment may include a data storing unit 100 that stores information and data. The data storing unit 100 stores digital information obtained from plural computers or servers in a digital information storage area 101 for use in analysis of a lawsuit or an illegality inspection.

Further, the data storing unit 100 includes an inspection base database 103 that stores a category attribute indicating that information belongs to either category of a lawsuit case including antitrust, patents, FCPA or PL, or an illegality inspection including information leakage or false invoicing, a company name, a person in charge, a custodian, and a configuration of an inspection or classification input screen; a keyword database 104 that registers a specific classification code of a document included in the obtained digital information, a keyword having a close relationship with the specific classification code, and keyword correspondence information indicating a correspondence relationship between the specific classification code and the keyword; a related term database 105 that registers a predetermined classification code, a related term formed by a word having a high appearance frequency in a document to which the predetermined classification code is assigned, and related term correspondence information indicating a correspondence relationship between the predetermined classification code and the related term; and a score calculation database 106 that registers a weight of a word included in a document to calculate a score indicating the strength of connection between the document and the classification code.

Further, the data storing unit 100 stores a report preparation database 107 that registers the format of a report determined according to the content of a category, a custodian, and classification work. The data storing unit 100 may be provided in the document analysis system 1, as shown in FIG. 1, or may be provided outside the document analysis system 1 as a separate storage device.

The document analysis system 1 according to the embodiment of the invention includes a database managing unit 109 that manages updating of the data content of the inspection base database 103, the keyword database 104, the related term database 105, the score calculation database 106, and the report preparation database 107.

The database managing unit 109 may be connected to an information storage device 902 through an exclusive connection line or an internet line 901. Further, the database managing unit 109 may update the data content of the inspection base database 103, the keyword database 104, the related term database 105, the score calculation database 106, and the report preparation database 107, based on the content of the data stored in the information storage device 902.

The document analysis system 1 according to the embodiment of the invention may include a document extracting unit 112 that extracts plural documents from the document information, a word retrieving unit 114 that retrieves a keyword or a related term recorded in the database from the document information, and a score calculating unit 116 that calculates the score indicating the strength of connection between the document and the classification code.

The document analysis system 1 according to the embodiment of the invention may include a first automatic classifying unit 201 that retrieves the keyword recorded in the keyword database 104 by the word retrieving unit 114, extracts a document including the keyword from the document information, and automatically assigns a specific classification code to the extracted document based on the keyword correspondence information; and a second automatic classifying unit 301 that extracts a document including the related term recorded in the related term database from the document information, calculates the score based on an evaluation value of the related term included in the extracted document and the number of the related terms, and automatically assigns a predetermined classification code to a document in which the score exceeds a predetermined value, among the documents including the related term, based on the score and the related term correspondence information.

Further, the document analysis system 1 according to the embodiment may include a document display unit 130 that displays plural documents extracted from the document information on a screen; a classification code receiving and assigning unit 131 that receives, with respect to plural documents to which classification codes are not assigned, extracted from the document information, a classification code assigned by a user based on the relevance with a lawsuit to assign the classification code; a document analyzing unit 118 that analyzes the document to which the classification code is assigned by the classification code receiving and assigning unit 131; and a third automatic classifying unit 401 that automatically assigns a classification code based on the analysis result obtained by analyzing the document to which the classification code is assigned by the classification code receiving and assigning unit 131 by the document analyzing unit 118.

Furthermore, the document analysis system 1 according to the embodiment of the invention may include a language determining unit 120 that determines the kind of a language of the extracted document, and a translating unit 122 that translates the extracted document in an automatic manner or according to reception of a user's designation. Division of languages in the language determining unit 120 is made shorter than one sentence in order to handle a complex language in which multiple languages are present in one sentence. Further, a process of deleting an HTML header or the like from a translation target may be performed.

In addition, the document analysis system 1 according to the embodiment of the invention may include a tendency information generating unit 124 that generates tendency information indicating a similarity degree of each document with respect to the document to which the classification code is assigned, based on the type of a word included in each document, the number of appearances of the word, and an evaluation value of the word, for the analysis in the document analyzing unit 118.

In addition, the document analysis system 1 according to the embodiment of the invention may include a quality inspecting unit 501 that compares the classification code received by the classification code receiving and assigning unit 131 with the classification code assigned by the tendency information in the document analyzing unit 118 to verify the validity of the classification code received by the classification code receiving and assigning unit 131.

Further, the document analysis system 1 according to the embodiment of the invention may include a learning unit 601 that learns a weight of each word or related term, based on the result of the document analysis process.

The document analysis system 1 according to the embodiment of the invention may include a report preparing unit 701 that performs an output of an optimal inspection report according to the inspection type of the lawsuit case or the illegality inspection, based on the result of the document analysis process. The lawsuit case includes antitrust (cartel), patents, the Foreign Corrupt Practices Act (FCPA), or products liability (PL), for example. Further, the illegality inspection includes information leakage or false invoicing, for example.

The document analysis system 1 according to the embodiment of the invention may include a lawyer review receiving unit 133 that receives chief lawyer or patent attorney's review, in order to enhance the quality of the classification inspection and report.

For ease of understanding of the document analysis system 1 according to the embodiment of the invention, specific terms in the embodiment will be described below.

The “classification code” refers to an identifier used in classifying documents, which represents a degree of relevance with a lawsuit for easy use in the lawsuit. For example, when the document information is used as evidence in the lawsuit, the classification code may be assigned according to the type of the evidence.

The “document” refers to data including one or more words. As an example of the “document”, an electronic mail, a presentation material, a spreadsheet material, a meeting reference, a contract, an organization chart, a business plan or the like may be used.

The “word” refers to a gathering of a minimum character string having a meaning. For example, in the sentence “document refers to data including one or more words”, words of “document”, “one”, “or more”, “words”, “including”, “data”, and “refers to” are included.

The “keyword” refers to a gathering of a character string having a certain meaning in a certain language. For example, in selecting a keyword from the sentence “classify a document”, “document” and “classify” may be used as the keywords. In the embodiment, a keyword such as “infringement”, “lawsuit” or “Patent Publication No” is frequently selected.

In the present embodiment, it is assumed that the keyword includes a morpheme.

Further, the “keyword correspondence information” refers to information indicating a correspondence relationship between a keyword and a specific classification code. For example, when a classification code “important” indicating an important document in a lawsuit has a close relationship with a keyword “infringer”, the “keyword correspondence information” may represent information that associates the classification code “important” with the keyword “infringer” for management.

The “related term” represents a word having an evaluation value that is equal to or higher than a predetermined value among words common to documents to which a predetermined classification code is assigned and having a high appearance frequency. For example, the appearance frequency represents an appearance ratio of the related term with respect to the total number of words that appear in one sentence.

Further, the “evaluation value” represents the amount of information that each word shows in a certain sentence. The “evaluation value” may be calculated with reference to the amount of transmission information. For example, when a predetermined brand name is assigned as the classification code, the “related term” may indicate a name of a technical field to which each commodity belongs, a sales country of the commodity, a name of a similar commodity to the commodity, or the like. Specifically, when the commodity name of the apparatus that performs an image encoding process is assigned as the classification code, the “related term” may be “encoding”, “Japan”, “encoder”, or the like.

The “related term correspondence information” represents a correspondence relationship between the related term and the classification code. For example, when a classification code called “product A” that is a commodity name in a lawsuit has a related term “image encoding” that is a function of the product A, the “related term correspondence information” may represent information that associates the classification code “product A” with the related term “image encoding” for management.

The “score” represents a value obtained by quantitatively evaluating the strength of connection with a specific classification code in a certain document. In each embodiment of the invention, for example, the score is calculated by words that appear in a document and an evaluation value of each word, using the following expression (1).

Scr=Σᵢ₌₀^{N}i*(mᵢ*wgtᵢ²)/Σᵢ₌₀^{N}i*wgtᵢ² (1)

Scr: score of document

mᵢ: appearance frequency of i-th keyword or related term

wgt²ᵢ: weight of i-th keyword or related term

Further, the document analysis system 1 of the invention may extract a word that frequently appears in documents to which the classification code assigned by a user is common. In addition, the document analysis system 1 may analyze the type of the extracted word, the evaluation value of each word, and the tendency information of the number of appearances, for each document, and may assign the common classification code to the documents having the same tendency as the analyzed tendency information among the documents of which the classification code is not received by the classification code receiving and assigning unit 131.

Here, the “tendency information” represents a similarity degree of each document with respect to the document to which the classification code is assigned, which represents a degree of relevance with a predetermined classification code, based on the type of a word included in each document, the number of appearances of the word, and the evaluation value of the word. For example, when each document is similar to the document to which the predetermined classification code is assigned in the degree of relevance with the predetermined classification code, it is said that two documents have the same tendency information. Further, if words having the same evaluation value are included in documents with the same number of appearances, even though the types of the words included in the documents are different from each other, two documents may be handled as documents having the same tendency.

Next, the document analysis method of the invention will be described.

The document analysis method of the invention is a method for obtaining digital information recorded in plural computers or servers, analyzing document information configured by plural documents, included in the obtained digital information, and providing the information for easy use in a lawsuit or an illegality inspection, and includes an inspection category input receiving step of receiving an input of a category of the lawsuit or the illegality inspection, an inspection step of performing an inspection based on the category received by the inspection category input receiving unit, and a report preparation step of preparing a report for reporting the result of the inspection performed by the inspecting unit.

Subsequently, details of the document analysis method of the invention will be described with reference to the accompanying drawings. Examples described hereinafter are only examples, and the invention is not limited thereto.

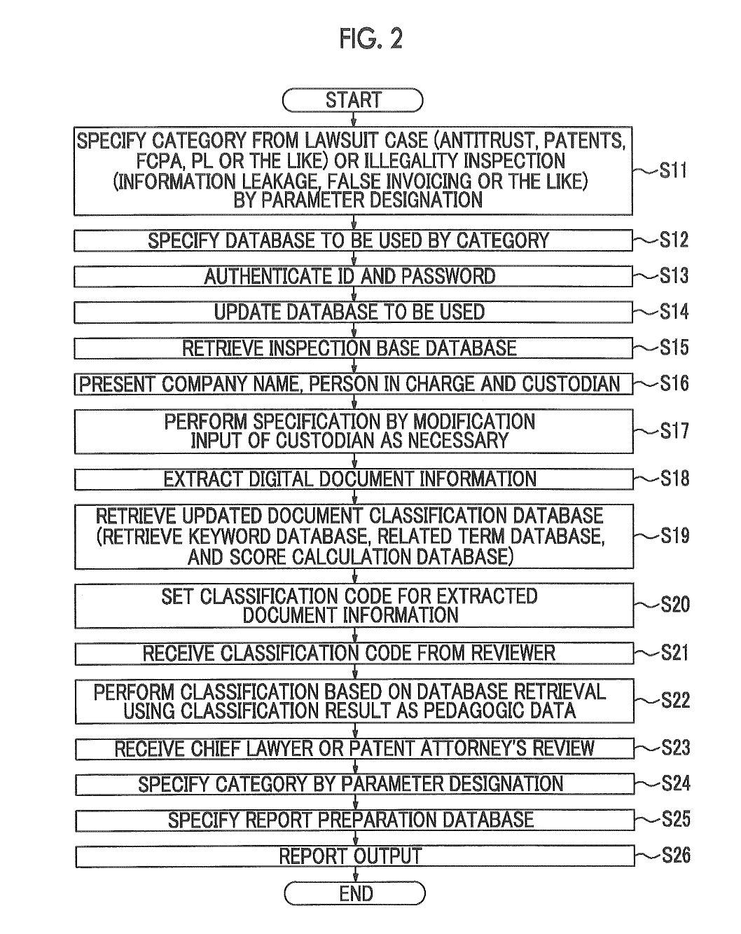

FIG. 2 is a flowchart illustrating a document analysis method according to an embodiment of the invention. The document analysis method according to the embodiment of the invention will be described with reference to FIG. 2.

By receiving designation of a parameter from the user according to display of the display screen of the display unit, for example, a category of a lawsuit case including antitrust, patents, FCPA or PL, or an illegality inspection including information leakage or false invoicing may be specified (S11).

A database to be used, such as the inspection base database or the document analysis database may be specified according to the specified category (S12).

In order to check whether the database to be used is the latest one, access to the information storage device that stores the latest database may be performed. The information storage device may be provided inside an organization where classification is performed, or may be provided outside the organization. As an example in which the information storage device is provided outside the organization, there is a case where the information storage device is provided in a law firm or a patent law firm that cooperates with the organization.

When the access to the information storage device is performed, authentication using an ID and a password may be performed to retain security (S13).

After the authentication is performed, the access to the information storage device is permitted, and then, the database to be used such as the inspection base database or the document analysis database may be updated to a guided database (S14).

The updated inspection base database may be retrieved (S15), and then, a company name, a person in charge, and a name of a custodian may be presented on the screen of the display device (S16).

When the person in charge and the name of the custodian displayed on the screen of the display device are different from an actual person in charge and a name of an actual custodian, the user modifies the person in charge and the name of the custodian on the screen of the display device. The document analysis device may receive the modification input of the user to specify the actual person in charge and the name of the actual custodian (S17).

Then, in order to perform the document analysis operation, it is possible to extract the digital document information (S18).

As the updated document analysis database, the updated keyword database, related term database, and score calculation database may be retrieved (S19), and the classification code may be assigned to the extracted document information (S20).

Further, the classification code may be received by a reviewer, and then, the classification code may be assigned to the extracted document information (S21).

The database may be retrieved using the classification result as pedagogic data, and then, the classification code may be assigned to the extraction document information (S22).

A review from chief lawyer or patent attorney's review may be received (S23). Thus, it is possible to enhance the quality of the inspection.

The category may be specified by parameter designation of the user (S24), and then, the report preparation database may be specified according to the specified category (S25). The format of the report may be determined by the specified report preparation database, and then, the report may be automatically output (S26).

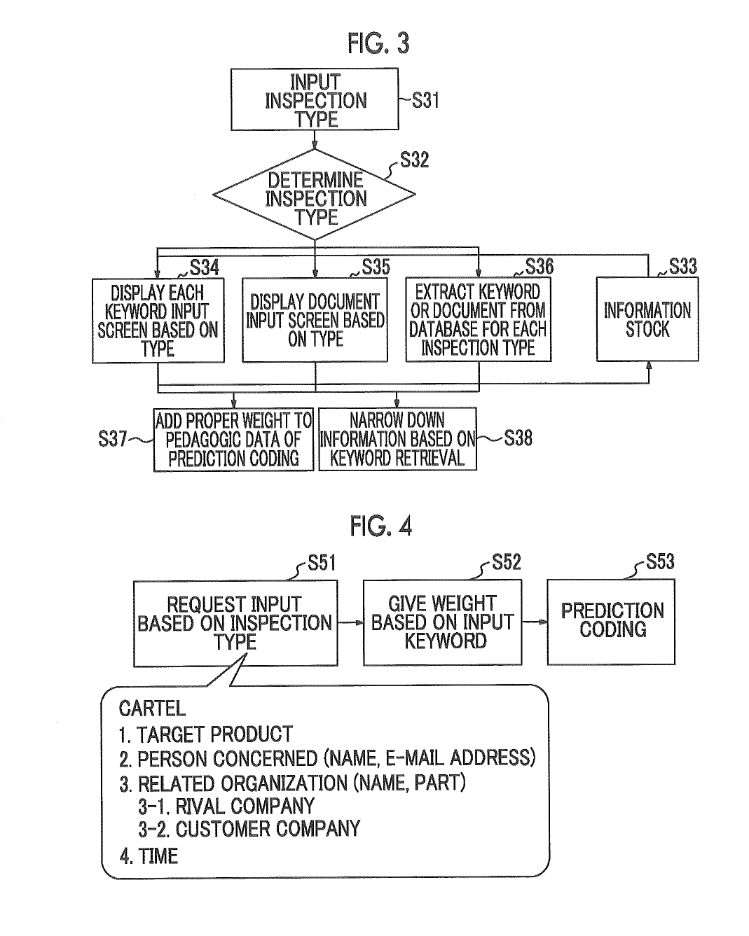

FIG. 3 is a chart illustrating the flow of an inspection and classification process according to the type of inspection in the document analysis method according to an embodiment of the invention.

First, the type of the inspection may be input (S31). Namely, the user inputs a category corresponding to an inspection and classification operation to be performed from the lawsuit case including antitrust, patents, FCPA or PL, or the illegality inspection including information leakage or false invoicing, for example, according to display of the display screen. The document analysis system may receive the input of the category of the user to specify the category of the inspection target.

The type of the inspection and document analysis process and the type of the database to be used may be determined according to the specified category (S32).

Access to a stock of information stored in the database to be used such as the inspection base database or the document analysis database may also be performed according to the specified category (S33).

By performing the access to the inspection base database according to the specified category, it is possible to display each keyword input screen based on the specified category (S34).

By performing the access to the inspection base database according to the specified category, it is possible to display each sentence input screen based on the specified category (S35).

By performing the access to the inspection base database according to the specified category, it is possible to extract a keyword or a document according to the specified category (S36).

By performing the above-described process, it is possible to additionally give a weight to the pedagogic data of automatic classification code assignment (prediction coding) (S37).

By retrieving keywords from the document analysis database, it is possible to narrow down the extracted documents and information (S38).

FIG. 4 is a chart illustrating the flow of the prediction coding process according to the type of an inspection in the document analysis method according to the embodiment of the invention.

In the document analysis method according to the embodiment of the invention, first, the document analysis system may request an input according to the type of the inspection of the user, and may receive the input of the user therefor. For example, the document analysis system may request, of the user, an input of a target product, a relevant person (name and e-mail address), a relevant organization (name and part), and a time, with respect to a cartel associated with an antitrust law, and may receive the input of the user therefor. Further, the document analysis system may request, of the user, an input of a rival company and a customer company with respect to the relevant organization, and may receive the input of the user therefor (S51).

Next, a weight for the classification code assignment may be given by the input keyword (S52). Thus, the prediction coding may be performed (S53).

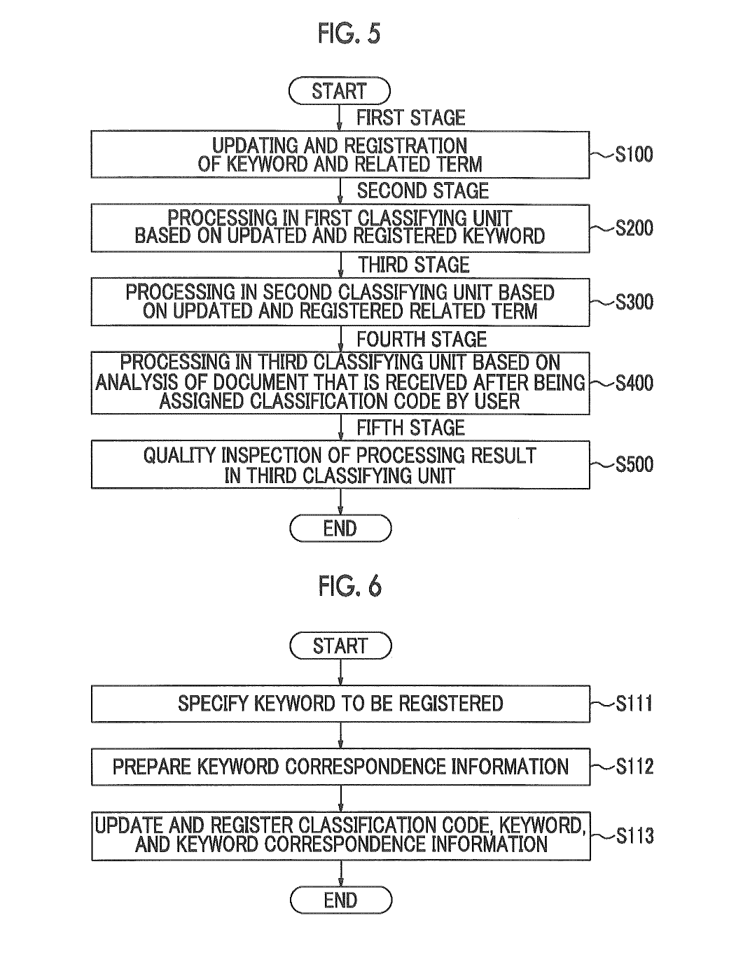

In the embodiment of the invention, as an example, a registration process, a classification process, and an inspection process are performed in first to fifth stages, according to the flowchart shown in FIG. 5.

In the first stage, the keyword and the related term are updated and registered in advance using the result of the previous classification process (S100). Here, the keyword and the related term are updated and registered together with keyword correspondence information and related term correspondence information that are correspondence information of the classification code and the keyword or the related term.

In the second stage, a first classification process of extracting a document including the keyword that is updated and registered in the first stage from all document information, and assigning, if the document is found, the classification code corresponding to the keyword to the document with reference to the updated keyword recorded in the first stage is performed (S200).

In the third stage, the document including the related term that is updated and registered in the first stage is extracted from the document information to which the classification code is not assigned in the second stage, and the score of the document including the related term is calculated. A second classification process of executing assignment of the classification code with reference to the calculated score and the related term correspondence information that is updated and registered in the first stage is performed (S300).

In the fourth stage, the classification code assigned by the user for the document information to which the classification code is not assigned up to the third stage is received, and the classification code received from the user is assigned to the document information. Then, a third classification process of analyzing the document information to which the classification code received from the user is assigned, extracting the document to which the classification code is not assigned based on the analysis result, and assigning the classification code to the extracted document is performed. For example, a word that frequently appears in the documents that are common to the classification code assigned by the user is extracted, the type of the extracted word included in each document, the evaluation value of the word, and the tendency information of the number of appearances are analyzed for each document, and the common classification code is assigned to the document having the same tendency as the tendency information (S400).

In the fifth stage, the user determines the classification code to be assigned based on the analyzed tendency information for the document to which the classification code is assigned in the fourth stage, compares the determined classification code with the classification code assigned by the user, and verifies the validity of the classification process (S500). Further, a learning process may be performed based on the result of the document analysis process as necessary.

The tendency information used in the fourth stage and the fifth stage represents a similarity degree of each document with respect to the document to which the classification code is assigned, which is based on the type of a word included in each document, the number of appearances of the word, and the evaluation value of the word. For example, it is said that when each document is similar to the document to which a predetermined classification code is assigned in the degree of relevance with the predetermined classification code, two documents have the same tendency information. Further, if words having the same evaluation value are included in documents with the same number of appearances, even though the types of the words included in the documents are different from each other, two documents may be handled as documents having the same tendency.

Detailed processing flows in the respective stages of the first to fifth stages will be described hereinafter.

First Stage (S100)

A detailed processing flow of the keyword database 104 in the first stage will be described with reference to FIG. 6.

The keyword database 104 prepares a management table for each classification code based on a document classification result in a previous lawsuit, and specifies a keyword corresponding to each classification code (S111). In the embodiment of the invention, this specification is performed by analyzing the document to which each classification code is assigned and using the number of appearances and the evaluation value of each keyword in the document, but a method that uses the amount of transmission information included in the keyword, a method in which a user performs manual selection, or the like may be used.

In the embodiment of the invention, for example, when the keyword such as “infringement” or “patent attorney” as the keyword of the classification code “important” is specified, keyword correspondence information indicating that the “infringement” and “patent attorney” are keywords having a close relationship with the classification code “important” is prepared (S112). Then, the specified keywords are registered in the keyword database 104. Here, the specified keywords in association with the keyword correspondence information are stored in the management table of the classification code “important” of the keyword database 104 (S113).

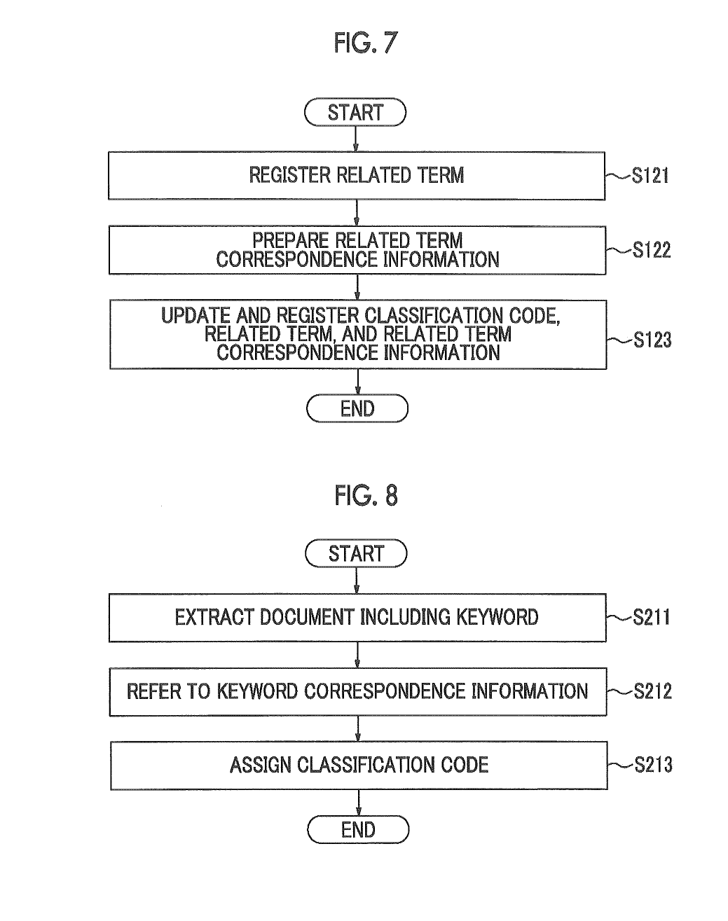

Next, a detailed processing flow of the related term database 105 will be described with reference to FIG. 7. The related term database 105 prepares a management table for each classification code based on the document classification result in the previous lawsuit, and registers the related term corresponding to each classification code (S121). In the embodiment of the invention, for example, “encoding” and “product a” are registered as the related terms of “product A”, and “decoding” and “product b” are registered as the related terms of “product B”.

The related term correspondence information indicating which classification code each registered related term corresponds to is prepared (S122), and is recorded in each management table (S123). Here, an evaluation value of each related term and a threshold value that is a score necessary for determination of the classification code are also recorded in the related term correspondence information.

Before actually performing the classification operation, the keyword and the keyword correspondence information, and the related term and the related term correspondence information are updated to the latest one for registration (S113 and S123).

Second Stage (S200)

A detailed processing flow of the first automatic classifying unit 201 in the second stage will be described with reference to FIG. 8. In the embodiment of the invention, in the second stage, a process of assigning the classification code “important” to a document is performed by the first automatic classifying unit 201.

In the first automatic classifying unit 201, a document including the keywords “infringement” and “patent attorney” registered in the keyword database 104 in the first stage (S100) is extracted from the document information (S211). The management table in which the keyword is recorded is referred to from the keyword correspondence information (S212), and the classification code “important” is assigned (S213) to the extracted document.

Third Stage (S300)

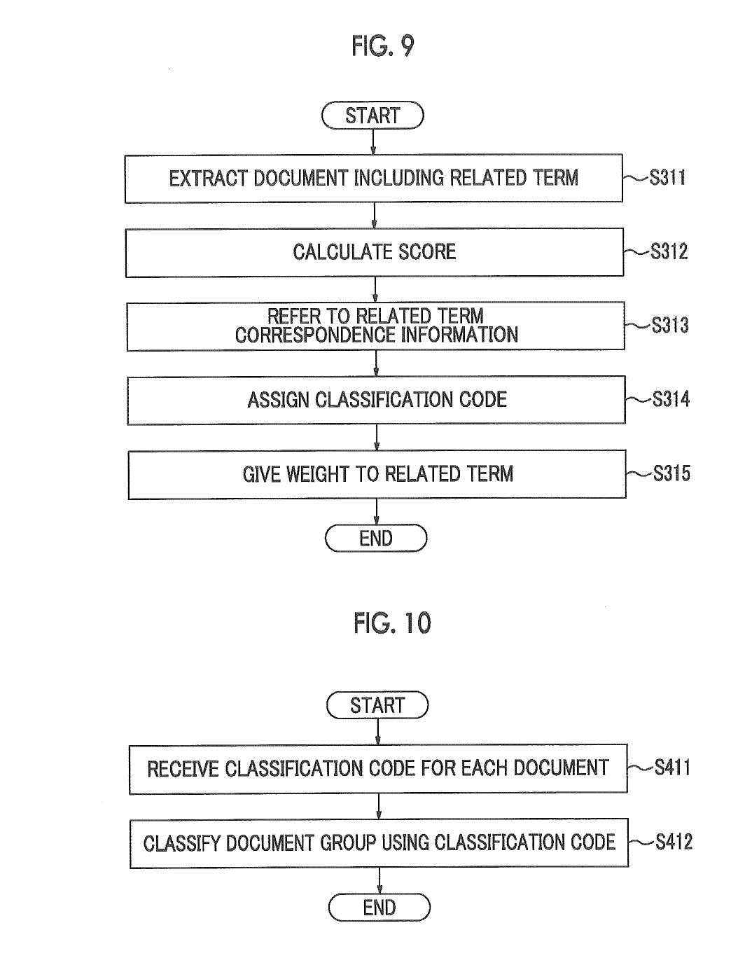

A detailed processing flow of the second automatic classifying unit 301 in the third stage will be described with reference to FIG. 9.

In the embodiment of the invention, in the second automatic classifying unit 301, a process of assigning the classification code “product A” and “product B” to the document information to which the classification code is not assigned in the second stage (S200) is performed.

The second automatic classifying unit 301 extracts a document including the related terms “encoding”, “product a”, “decoding” and “product b” recorded in the related term database 105 in the first stage from the document information (S311). A score is calculated by the score calculating unit 116 using the above-mentioned expression (1) based on appearance frequencies and evaluation values of the recorded four related terms, with respect to the extracted document (S312). The score represents a degree of relevance of each document with the classification codes “product A” and “product B”.

When the score exceeds the threshold value, the related term correspondence information is referred to (S313), and an appropriate classification code is assigned (S314).

For example, when the appearance frequencies of the related terms “encoding” and “product a” in a certain document and the evaluation value of the related term “encoding” are high, and the score indicating the degree of relevance with the classification code “product A” exceeds the threshold value, the classification code “product A” is assigned to the document.

Here, when the appearance frequency of the related term “product b” in the document is high, and the score indicating the degree of relevance with the classification code “product B” exceeds the threshold value, “product B” is also assigned to the document, together with the classification code “product A”. On the other hand, when the appearance frequency of the related term “product b” in the document is low and the score indicating the degree of relevance with the classification code “product B” does not exceed the threshold value, only the classification code “product A” is assigned to the document.

In the second automatic classifying unit 301, the evaluation value of the related term is calculated again, and a weight of the evaluation value is given, by the following expression (2) using the score calculated in S432 in the fourth stage (S315).

wgt_{i,L}=\sqrt{wgt_{L-i}²⁺γ_{L}wgt_{i,L}²−θ}=\sqrt{wgt_{i,L}²+Σₗ₌₁^{L}(γₗwgt_{i,l}²−θ)} (2)

wgt_{i,0}: weight of i-th selected keyword before learning

wgt_{i,L}: weight of i-th selected keyword after L-th learning

γ_{L}: learning parameter in L-th learning

θ: threshold value of learning effect

For example, when a predetermined number of documents having an abnormally high appearance frequency of “decoding” but having scores which is equal to or lower than a predetermined value occur, the evaluation value of the related term “decoding” is lowered again, and is recorded in the related term correspondence information.

Fourth Stage (S400)

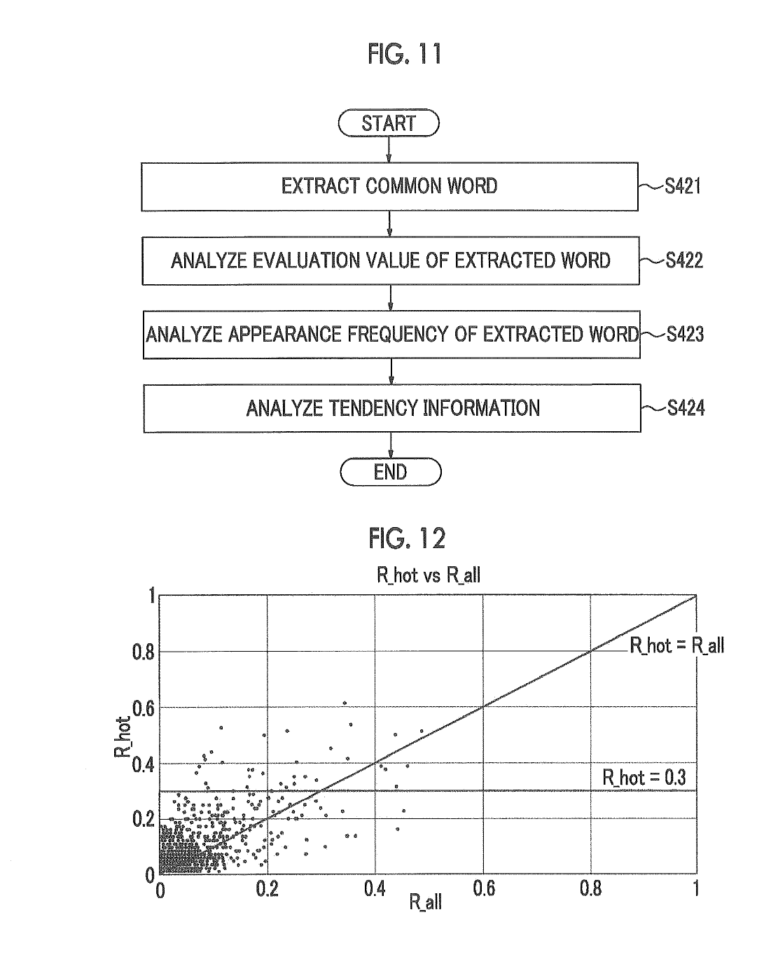

In the fourth stage, as shown in FIG. 10, assignment of the classification code from a reviewer for a predetermined ratio of the document information extracted from the document information to which the classification code is not assigned in the processes up to the third stage is received, and the received classification code is assigned to the document information. Then, as shown in FIG. 11, the document information to which the classification code received from the reviewer is assigned is analyzed, and the classification code is assigned to the document information to which the classification code is not assigned based on the analysis result. In the embodiment of the invention, in the fourth stage, a process of assigning the classification codes, for example, “important”, “product A”, and “product B” to the document information is performed. The fourth stage will be further described hereinafter.

A detailed processing flow of the classification code receiving and assigning unit 131 in the fourth stage will be described with reference to FIG. 10. First, the document extracting unit 112 randomly samples documents from the document information that is the processing target in the fourth stage, and displays the sampled documents in the document display unit 130. In the embodiment of the invention, 20% of the documents in the document information that is the processing target is randomly extracted to be used as a classification target by the viewer. The sampling may be performed by an extraction method of arranging the documents in the order of document preparation dates or document names and selecting 30% of the documents from the top.

The user browses the display screen 11 shown in FIG. 16 displayed in the document display unit 130, and selects a classification code to be assigned to each document. The classification code receiving and assigning unit 131 receives the classification code selected by the user (S411), and performs classification based on the assigned classification code (S412).

Next, a detailed processing flow of the document analyzing unit 118 will be described with reference to FIG. 11. The document analyzing unit 118 extracts a word that is common to and frequently appears in the documents classified for each classification code by the classification code receiving and assigning unit 131 (S421). The evaluation value of the extracted common word is analyzed by the above-mentioned expression (2) (S422), and the appearance frequency in the document of the common word is analyzed (S423).

Further, the tendency information of the document to which the classification code “important” is assigned is analyzed based on the analysis result in S422 and S423 (S424).

FIG. 12 is a graph illustrating an analysis result in S424 with respect to the words that are common to and frequently appear in the documents to which the classification code “important” is assigned.

In FIG. 12, a longitudinal axis R_hot represents the ratio of the documents that include a word selected as a word related to the classification code “important”, to which the classification code “important” is assigned, among all the documents to which the classification code “important” is assigned by the user. A transverse axis represents the ratio of the documents that include the word extracted in S421 by the classification code receiving and assigning unit 131 among all the documents for which the user performs the classification process.

In the embodiment of the invention, the classification code receiving and assigning unit 131 extracts the words that are plotted in an upper part with reference to a straight line R_hot=R_all as common words in the classification code “important”.

The processes of S421 to S424 are also executed for the document to which the classification codes “product A” and “product B” are assigned, and the tendency information of the document is analyzed.

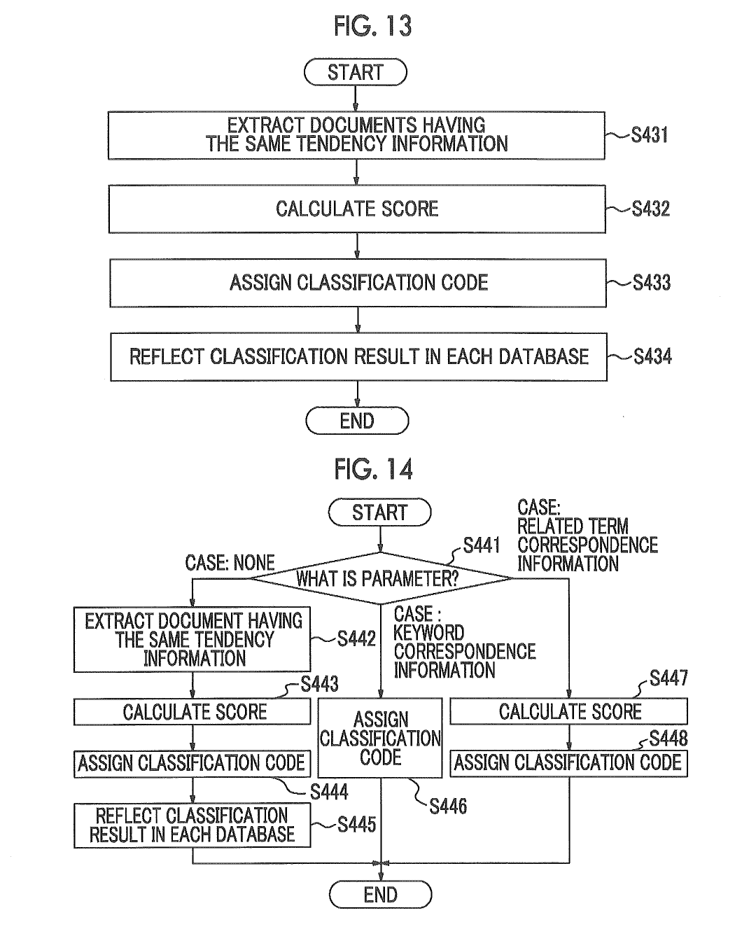

Next, a detailed processing flow of the third automatic classifying unit 401 will be described with reference to FIG. 13. In the third automatic classifying unit 401, a process is performed for the document in which the assignment of the classification code is not received by the classification code receiving and assigning unit 131 in S411 among the document information that is the processing target in the fourth stage. The third automatic classifying unit 401 extracts the tendency information of the document to which the classification codes “important”, “product A”, and “product B” are assigned, analyzed in S424, among these documents, and the documents having the same tendency information (S431), and calculates the score using the above-mentioned expression (1) based on the tendency information with respect to the extracted documents (S432). Further, the third automatic classifying unit 401 assigns an appropriate classification code to the documents extracted in S431 based on the tendency information (S433).

In the third automatic classifying unit 401, the classification result is reflected in each database using the score calculated in S432 (S434). Specifically, a process of lowering evaluation values of a keyword and a related term included in the documents having a low score and increasing evaluation values of a keyword and a related term included in a document having a high score may be performed.

Further, an example of the detailed processing flow of the third automatic classifying unit 401 will be described with reference to FIG. 14. In the third automatic classifying unit 401, the classification process may be performed for the documents to which the assignment of the classification code is not received by the classification code receiving and assigning unit 131 in S411, among the document information that is the processing target in the fourth stage. When a parameter is not given (S441: No), the third automatic classifying unit 401 extracts the tendency information of the documents to which the classification code “important” is assigned, analyzed in S424, and the documents having the same tendency information from the documents (S442), and calculates the scores for the extracted documents using the above-mentioned expression (1) based on the tendency information (S443). Further, the third automatic classifying unit 401 assigns an appropriate classification code to the documents extracted in S442 based on the tendency information (S444).

In the third automatic classifying unit 401, the classification result is reflected in each database using the scores calculated in S443 (S445). Specifically, a process of lowering evaluation values of a keyword and a related term included in a document having a low score and increasing evaluation values of a keyword and a related term included in a document having a high score is performed.

As described above, the score calculation may be performed by both of the second automatic classifying unit 301 and the third automatic classifying unit 401, and when the number of times of score calculation is large, the data for the score calculation may be stored in the score calculation database 106 in a batch.

Fifth Stage (S500)

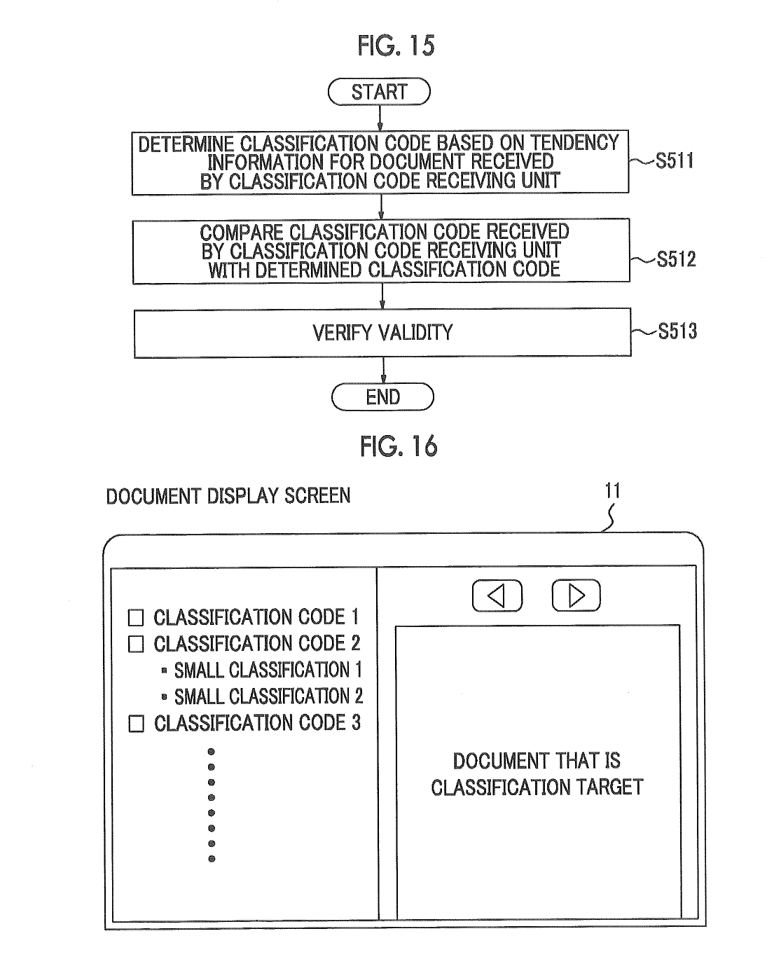

A detailed processing flow of the quality inspecting unit 501 in the fifth stage will be described with reference to FIG. 15. First, the quality inspecting unit 501 determines a classification code to be assigned based on the tendency information analyzed by the document analyzing unit 118 in S424, with respect to the document received in S411 by the classification code receiving and assigning unit 131 (S511).

The classification code received by the classification code receiving and assigning unit 131 and the classification code determined in S511 are compared with each other (S512), and the validity of the classification code received in S411 is verified (S513).

The document analysis system 1 according to the embodiment of the invention may include the learning unit 601. The learning unit 601 learns a weight of each keyword or related term by the above-mentioned expression (2), based on the first to fourth processing results. The learning result may be reflected in the keyword database 104, the related term database 105 or the score calculation database 106.

The document analysis system 1 according to the embodiment of the invention may include the report preparing unit 701 for outputting an optimal inspection report according to the inspection type of the lawsuit case (for example, cartel, patents, FCPA or PL in the lawsuit) or the illegality inspection (for example, information leakage or false invoicing) based on the result of the document analysis process.

Inspection content is changed according to the inspection type.

For example, in the case of a cartel, the following points are considered.

1. When and how did competing parties perform a communication (price adjustment) relating to the cartel?

2. Who is a concerned person and which organization does the concerned person belong to?

Further, in the case of patent infringement, the following points are considered.

1. Is the content equivalent to a technique that is an infringement target?

2. Who infringed the technique? When did the infringement occur? Was the infringement performed with a certain intention (or without intention)? Otherwise, did such an infringement not occur?

A document inspection report system, a document inspection report method, and a document inspection report program according to another example of the embodiment of the invention will be described.

In the document inspection report system according to another example of the embodiment of the invention, a document to which a classification code is already assigned corresponding to similar retrieval information is analyzed, and a range where the classification code is assigned is adjusted based on the analysis result. Further, a classification operation and an inspection operation are performed based on the adjusted range where the classification code is assigned, and a report is prepared based on the result of the classification operation and the inspection operation.

As a method for adjusting the range where the classification code is assigned corresponding to the similar retrieval information, a method for adjusting the range where the classification code is assigned corresponding to the similar retrieval information by clustering the similar retrieval information, and a method for learning the classification result to perform prediction classification are used. In the method for adjusting the range where the classification code is assigned corresponding to the similar retrieval information by clustering the similar retrieval information, for example, there is a case where a common classification code is assigned to an original document, a document in reply to the original document, and a document in replay to the document in reply to the original document, in consideration of a common characteristic of metadata. In the method for learning the classification result to perform the prediction classification, the same or similar classification code is assigned to the similar retrieval information by performing learning so that the similar retrieval information is integrated for the classification result.

In another example of the embodiment of the invention, the reliability of the analysis result is changed by the number of documents that are the analysis target. By applying a statistical method to all the documents that are the classification target, it is also possible to determine the adjustment of an arrangement range of the classification code, based on the analysis result, with respect to a certain ratio of all the documents at a certain time.

In another example of the embodiment of the invention, as the method for adjusting the range where the classification code is assigned corresponding to the similar retrieval information, the range of the document to which the classification code is assigned may be adjusted by executing both of the method for adjusting the range where the classification code is assigned corresponding to the similar retrieval information by clustering the similar retrieval information and the method for learning the classification result to perform the prediction classification.

In the document inspection report system, the document inspection report method, and the document inspection report program according to another example of the embodiment of the invention, the report is prepared based on the classification operation and the inspection result.

Thus, in the document inspection report system, the document inspection report method, and the document inspection report program according to another example of the embodiment of the invention, it is possible to rapidly prepare a precise inspection report, and to reduce the burden involved in the classification operation and the report preparation operation.

The document analysis program of the invention is a document analysis program for obtaining digital information recorded in plural computers or servers, analyzing document information configured by plural documents, included in the obtained digital information, and providing the document information for easy use in a lawsuit or an illegality inspection, which causes a computer to execute: an inspection category input receiving function of receiving an input of a category of the lawsuit or the illegality inspection; an inspection function of performing an inspection based on the category received through the inspection category input receiving function; and a report preparing function of preparing a report for reporting a result of the inspection performed through the inspection function.

The inspection category input receiving function may be realized by the above-described inspection category input receiving unit. Details thereof are as described above.

The inspection function may be realized by the above-described inspecting unit. Details thereof are as described above.

The report preparing function may be realized by the above-described report preparing unit. Details thereof are as described above.

In the embodiment of the invention, as the input of the user for the category of the lawsuit case or the illegality inspection case is received, the database is automatically updated according to the category. Thus, the burden of an office work of inputting names or the like of the person in charge, and the custodian is reduced. Further, a retrieving word is adjusted by the database that is automatically updated according to the category, and the classification code is automatically assigned to the document information using the adjusted retrieving word. Thus, the burden of the classification operation of the document information used in the lawsuit or illegality inspection case is reduced.

That is, according to the invention, the analysis of the document information used in the lawsuit is facilitated.

1. A document analysis system that obtains digital information recorded in a plurality of computers or servers, analyzes document information configured by a plurality of documents, included in the obtained digital information, and provides the document information for use in a lawsuit or an illegality inspection, said system comprising:
an inspection category input receiving unit that receives an input of a category of the lawsuit or the illegality inspection;
an inspecting unit that performs an inspection based on the category received by the inspection category input receiving unit;
a report preparing unit that prepares a report for reporting a result of the inspection performed by the inspecting unit,
an inspection base database that stores information relating to the lawsuit or the illegality inspection;
an inspection type determining unit that determines an inspection category which is an inspection target based on the category received by the inspection category input receiving unit, and extracts a type of necessary information from the inspection base database;
a display screen control unit that controls a display screen that presents the type of the information extracted by the inspection type determining unit to a user;
an input receiving unit that receives an input of a keyword and/or a sentence from the user, corresponding to the type of the information presented in the display screen control unit; and
an automatic classification code assigning unit that automatically assigns a classification code to the document,
wherein the keyword and/or the sentence is used in the assignment of the classification code.

2. The document analysis system according to claim 1,
wherein the report preparing unit prepares a report suitable for the category received by the inspection category input receiving unit based on the result of the inspection performed by the inspecting unit.

3-5. (canceled)

6. The document analysis system according to claim 1, further comprising:
an information extracting unit that extracts a keyword and/or a sentence, corresponding to the type of the information extracted by the inspection type information determining unit, from the inspection base database.

7. The document analysis system according to claim 1, further comprising:
a retrieving unit that retrieves the keyword and/or the sentence from the document.

8. (canceled)

9. A document analysis method for obtaining digital information recorded in a plurality of computers or servers, analyzing document information configured by a plurality of documents, included in the obtained digital information, and providing the document information for use in a lawsuit or an illegality inspection, said method being performed by a document analysis system having an inspection base database that stores information relating to the lawsuit or the illegality inspection, said method comprising:
receiving an input of a category of the lawsuit or the illegality inspection;
performing an inspection based on the category received in the receiving of the input;
preparing a report for reporting a result of the inspection in the performing of the inspection;
determining an inspection category which is an inspection target based on the category received in the inspection category input receiving, and extracting a type of necessary information from the inspection base database;
controlling a display screen that presents the type of the information extracted in the inspection type determining step to a user;
receiving an input of a keyword and/or a sentence from the user, corresponding to the type of the information presented in the display screen; and
automatically assigning a classification code to the document,
wherein the keyword and/or the sentence is used in the assignment of the classification code.

10. A document analysis program for obtaining digital information recorded in a plurality of computers or servers, analyzing document information configured by a plurality of documents, included in the obtained digital information, and providing the document information for use in a lawsuit or an illegality inspection, the program causing a computer having an inspection base database that stores information relating to the lawsuit or the illegality inspection to execute functions, said functions comprising:
an inspection category input receiving function of receiving an input of a category of the lawsuit or the illegality inspection;
an inspection function of performing an inspection based on the category received through the inspection category input receiving function; and
a report preparing function of preparing a report for reporting a result of the inspection performed through the inspection function;
an inspection type determining function of determining an inspection category which is an inspection target based on the category received through the inspection category input receiving function, and extracting the type of necessary information from the inspection base database;
a display screen control function of controlling a display screen that presents the type of the information extracted through the inspection type determining function to a user;
an input receiving function of receiving an input of a keyword and/or a sentence from the user, corresponding to the type of the information presented in the display screen; and
an automatic classification code assigning function of automatically assigning a classification code to the document,
wherein the keyword and/or the sentence is used in the assignment of the classification code.
